(19) United States
(12) Patent Application Publication
(10) Pub. No.: US 2020/0316822 A1
(43) Pub. Date: Oct. 8, 2020

(54) Production of elastomer parts manufactured by duplication, based on a reference standard model

(71) Applicant: Biwi SA, Glovelier (CH)

(72) Inventor: Pascal Bourquard, Bassecourt (CH)

(21) Appl. No.: 16/736,119

(22) Filed: Jan. 7, 2020

(30) Foreign Application Priority Data
Apr. 5, 2019 (CH) 00465/19
Apr. 5, 2019 (EP) 19167660.0

(51) Int. Cl. B29C 33/38; B29C 33/40; B29C 43/00; B29C 43/36; B29C 43/18; B29C 43/52

(52) U.S. Cl. CPC B29C 33/3878; B29C 33/405; B29C 43/52; B29C 43/36; B29C 43/18; B29C 43/003

(57) ABSTRACT

The invention relates to the production of a textured moulding cavity, in particular for the moulding of elastomer parts with surface texturing. This method is based on the acquisition of a texture from a natural model whose surface condition is to be reproduced on an elastomer part by overmoulding the model between two calendered sheets of elastomeric material and vulcanization for a period between 20 minutes and 60 minutes at a temperature between 80° C. and 200° C. The invention also relates to a moulding cavity made of elastomeric material thus obtained and a method for moulding a textured elastomeric part obtained by vulcanization in the cavity of the invention of a sheet of raw calendered elastomeric material on a base element of the same partially vulcanized elastomeric material. Finally, the invention relates to a textured elastomer part obtained with the inventive moulding method.

### TECHNICAL FIELD

The present invention relates to the field of manufacturing elastomer parts. It more particularly relates to a method for creating a moulding cavity of an elastomer part with surface texturing, in particular a texturing of natural material type or a texturing obtained by own know-how.

The invention also relates to a method for moulding a part made of elastomeric material with surface texturing from such a cavity.

The invention can be advantageously applied to the field of watch making, luxury, leather goods, packaging, display cases, in particular packaging or other industrial sectors using rubber or various elastomers.

### STATE OF THE ART

It is known to manufacture parts such as watch straps, in natural or synthetic rubber, or in various plastic materials. These bracelets are generally made by moulding, the mould possibly including structures allowing graphic elements, such as a brand or logo, to appear on the bracelet, or sometimes a local or more extensive surface texture intended to provide a particular aesthetic and/or tactile effect. Only the relief makes it possible to discern the form or inscription, both visually and tactically.

However, it appears that the current moulding methods do not provide local or extensive surface texturing of an elastomer part that provides a faithful rendering of a texture of natural material such as leather, a feather, flaked skin, bark, etc. . . . such that the rendering of the textured part can, at least to the naked eye and/or to the touch, be confused with said natural material.

This is due in particular to the fact that the moulding cavities known to date do not make it possible to sufficiently accurately reproduce the textural fineness of natural materials, due to a lack of resolution of the methods of acquiring and/or reproducing surfaces of these natural materials.

Indeed, the elastomeric material moulding cavities are traditionally obtained by removing material with laser according to digital models obtained by computer-aided design or by shaping (stamping, moulding) a rigid metal or plastic cavity resistant to the vulcanization temperatures of the elastomeric materials to be moulded. Unfortunately, these techniques do not allow the industrial production, other than by manual final machining, of mould surfaces with granularities of not less than one millimeter, let alone one tenth of a millimeter. However, many natural or synthetic biological materials such as feathers, skins, hair, for example, have such surface dimensional variations, or simply individual dimensions so small that they cannot be moulded or reproduced accurately.

The purpose of this invention is to overcome the disadvantages of the methods for obtaining textured elastomer parts, such as, but not only, bracelets mentioned above.

### DISCLOSURE OF THE INVENTION

To achieve these goals, the invention relates to a method whose characteristics are mentioned in the claims.

More particularly, the invention, according to a first object, relates to a method for making a textured moulding cavity, in particular for moulding elastomer parts with surface texturing, comprising the following steps:
Provide a natural model whose surface condition is to be reproduced on an elastomer part;
Place the natural model between two sheets of a first calendered elastomeric material to form a cavity acquisition assembly;
Place the cavity acquisition assembly between two sheets of a second calendered elastomeric material different from the first calendered elastomeric material into elastomer so as to cover the cavity acquisition assembly;
Place the whole between two compression plates of a stoving shuttle and close said shuttle by tightening said two plates against each other so as to compress the sheets of second calendered material on the cavity acquisition assembly between said plates;
Heat the stoving shuttle for a period between 20 minutes and 60 minutes at a temperature between 80° C. and 200° C. to at least partially vulcanize each sheet of calendered elastomeric raw material and overmould said natural model in one face thereof;
Open the shuttle and remove the natural model from between the cavity acquisition blocks to obtain two textured moulding cavities comprising a sheet of calendered vulcanized elastomeric raw material at least partially vulcanized.

This method thus makes it possible to make a mould cavity of flexible and mass-textured elastomeric material, making it possible to obtain an extremely accurate negative, without alteration or finishing by machining, of the surface texture of any basic model, whether natural or not, in order to transfer this texture to a later moulded elastomer part, unlike the hard moulds known from the prior art.

The invention, according to a second object, also relates to a flexible moulding cavity obtained with this method.

Finally, the invention, according to a third object, relates to a method for moulding a part of elastomeric material and an elastomeric part obtained with this method, which includes the following steps:
a) —use a moulding cavity according to one of claims 6 to 8,
b) Place a sheet of raw calendered elastomeric material in said mould cavity;
c) Place on the sheet of raw calendered elastomeric material an element of partially vulcanized pre-moulded elastomeric material having substantially the shape of the part to be obtained, and
d) Place the mould cavity in which the sheet of raw elastomeric material and the pre-moulded element have been superimposed between two compression plates of a stoving shuttle and press said two plates together so as to compress the sheet of raw elastomeric material and the pre-moulded element into the cavity,
e) Heat the shuttle after closing to a temperature between 150° C. and 220° C., preferably between 160° C. and 200° C., for at least 30 minutes to vulcanize the sheet of raw elastomeric material and the pre-moulded element together to form a textured elastomer part;
f) After baking, separate the textured elastomer part thus formed, the face of which, obtained from the raw calendered material before baking in contact with the cavity, is textured.

### BRIEF DESCRIPTION OF THE DRAWINGS

Other characteristics and advantages of the present invention will appear more clearly upon reading the following description made with reference to the appended drawings wherein:

FIG. 1 schematically shows the different steps of the method for forming a mould cavity according to the invention and

FIG. 2 schematically shows the different steps of a method for moulding a textured elastomeric part using a cavity obtained according to the method of FIG. 1.

### EMBODIMENT(S) OF THE INVENTION

In the following description, the method for making a moulding cavity and then the method for moulding a textured elastomeric part using a cavity thus obtained will be described in particular in relation to the making of a watch strap strand. However, this application cannot be considered as limiting the scope of the present invention, which will apply equally to the production of mould cavities and textured elastomeric mouldings of all kinds and for all applications.

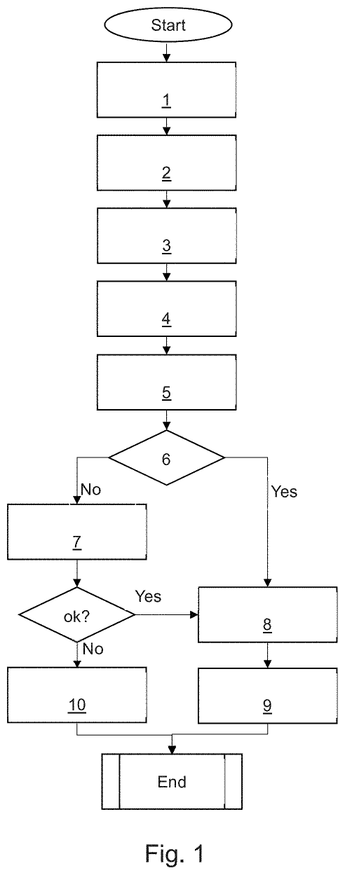

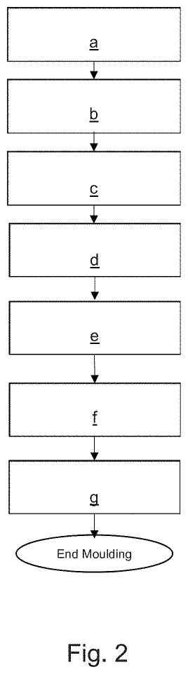

First of all, with reference to FIG. 1, the invention, according to a first object, relates to a method for making a textured moulding cavity. In contrast to the known mould cavities of the prior art and the manufacturing techniques thereof, the invention proposes the manufacture of cavities, i. e. flexible moulds, themselves made of elastomeric material, which have been overmoulded on a natural model in order to acquire the texture in its smallest details, like a negative, and then transfer the thus acquired texture to an elastomer moulded part during a moulding method described below in relation to FIG. 2 in particular.

The production of textured elastomeric cavities and their use in the moulding of textured elastomeric parts are also essential characteristics of the methods proposed by the invention.

According to the synoptic representation given in FIG. 1, the invention primarily relates to a method for acquiring a textured moulding cavity, in particular for moulding elastomer parts with surface texturing.

Before the actual cavity is supplied, it is advisable in a first step 1 to provide a model whose surface finish is to be reproduced on an elastomer part. Such a model can be of any nature and origin and have a very diverse, but preferably not smooth, i.e. with irregularities, surface finish. These irregularities may be extremely small, in particular of the order of a few tenths of a millimeter depth or length/width, or coarser, of the order of several millimetres or even centimeters. The model to be reproduced may preferably be a natural material of an animal, vegetable, lithographic or other nature. These may include, but are not limited to: skins, leather, hair coats, feathers, bark, rocks, etc.

Once the model has been selected, it is then necessary in a second step 2 to place it between two sheets of a first raw calendered elastomeric material to form a cavity acquisition assembly by vulcanizing said sheets of calendered elastomeric raw material.

The use of sheets of raw, i.e. unvulcanized calendered elastomeric material obtained by laminating elastomeric material to form calibrated strips and/or sheets, is of particular importance for the method of the invention. Indeed, such sheets make it possible to adjust the thickness and material of the cavity made according to the chosen model, without altering it but by perfectly “printing” the surface texture, by overmoulding, as will be described below.

Within the scope of the invention, calendered sheets with a thickness preferably between 0.5 mm and 10 mm, preferably still between 1 mm and 3 mm, will be used for the cavity acquisition assembly.

Each sheet of calendered, calibrated raw material is intended to provide a flexible half-mould of the overmoulded model, the thickness of which must be at least 10% thicker than half a thickness of the model. Thus, the invention, although not specifically limited to overmoulding models with a thickness greater than 10 mm, is in practice particularly suitable for obtaining textured cavities from models with relatively low thicknesses, less than one centimeter, a thickness that makes overmoulding with hard materials particularly delicate in practice.

The first elastomeric material constituting these calendered sheets will also be chosen from a fluorinated elastomeric material, in particular of the FKM type, or nitrile (NBR). A fluoroelastomer will be particularly suitable for overmoulding and texture acquisition from relatively dense and resistant materials such as leather, bark or stones, while nitrile will be more suitable for overmoulding fragile materials and fine surface roughness such as hair coats or feathers.

Once the model is sandwiched between two sheets of first calendered elastomeric material, a so-called cavity acquisition assembly is obtained, which is then placed in a third step 3 between two sheets of a second calendered elastomeric material, which is different from the first calendered elastomeric material, in order to cover the cavity acquisition assembly. The second calendered elastomeric material must be of a different nature from the first and preferably consists of raw or partially vulcanized ethylene propylene diene monomer (EPDM). Such a material has the advantage of not adhering to the first elastomeric material during the subsequent baking of the cavity.

The thus formed assembly must then be stoved to cure, and thus vulcanize, the sheets of calendered raw material around the model from which it is desired to acquire a texture. To do this, in a fourth step 4, said assembly is placed between two compression plates of a stoving shuttle, which is closed and tightened against each other in such a way as to compress the sheets, the cavity acquisition assembly between said sheets of the second calendered material and the shuttle plates.

Advantageously, the shuttle tightening plates each have a n inner silicone compression sole, said soles having a different Shore A hardness, in practice preferably between 20° and 30° Shore A for a first sole and between 40° and 50° Shore A for a second sole.

Such a difference in hardness between the soles is particularly advantageous because it provides a better compression of the cavity acquisition assembly, thus a better overmoulding of the model in the sheets of calendered elastomeric raw material, by pushing the hardest sole on said cavity acquisition assembly taken from the EPDM sheets into the softest sole.

Once the shuttle plates are tightened, said shuttle is then placed in a stove in a fifth step 5 in order to be heated with its contents for a period between 20 minutes and 60 minutes at a temperature between 80° C. and 200° C. to at least partially vulcanize each sheet of raw calendered elastomeric material and overmould said model in one face thereof.

For a majority of materials and models, a 30- to 45-minute baking time between 160° C. and 200° C. will be perfectly adapted to obtain a complete vulcanization of the first calendered material and obtain perfectly textured half-moulds of the surface of the chosen model. However, for fragile models, it is recommended to cook for up to 60 minutes at a lower temperature, between 120° C. and 150° C.

Once baking is complete, the shuttle is simply removed from the stove (or oven) and the latter is opened in a sixth step 6 to release the sheets of the second calendered elastomeric material and each textured cavity half-mould thus formed around the model obtained from the first vulcanized calendered elastomeric material is then released.

The quality of said cavities thus obtained from the first moulding is then checked, in particular their integrity and texturing quality. In case of defect 7 the manufacturing method is repeated as described above from new sheets of calendered first and second elastomeric materials, and of course so on until cavities of satisfactory quality are obtained.

Once the satisfactory cavities have been obtained 8, a subsequent etching or finishing step 9 can then be carried out, if necessary, in order to integrate certain additional textures or markings into the cavity, and then it is stored for use in a moulding method as described below. Unsatisfactory moulded cavities are discarded 10 and recycled.

Once a flexible textured elastomeric cavity has been obtained as previously described, the invention also proposes a method for moulding a part made of elastomeric material, for example, without limitation a piece of watch strap, textured according to the model obtained by the flexible cavity. Such a moulding method is schematically shown in FIG. 2.

The moulding method of the invention begins (a) with the provision of a moulding cavity as previously obtained, as well as a first pre-moulded elastomeric element, having substantially the form of the part to be obtained. This first pre-moulded element can result from a previous moulding, for example, by compressing an elastomer in a mould having the desired geometry, at a temperature that does not allow the elastomer to vulcanize.

A second step of the method consists in (b) placing a sheet of raw, i. e. uncured, calendered elastomeric material in the mould cavity, then (c) placing the first elastomeric element mentioned above on top thereof in said cavity. The sheet of raw calendered elastomeric material will thus be used to take the texture of the mould cavity and simultaneously coat the first elastomeric element during moulding and be fused therein by vulcanization as described below.

It should be noted that the sheet of raw calendered material and the first pre-moulded elastomeric element can be of different colours in order to create particular aesthetic effects if necessary. However, advantageously, the sheet of raw calendered material and the pre-moulded element will both be made of a similar elastomeric material so that they can be vulcanized together and provide a complete mechanical bond during the moulding. Preferably, a raw sheet and a pre-moulded element of ethylene propylene diene monomer (EPDM) may be chosen, the pre-moulded element being partially vulcanized, in particular at least at T30 and at most at T80 before the start of the final moulding.

The next step (d) consists, once this preparation has been carried out, in placing the mould cavity in which the sheet of raw elastomeric material and the pre-moulded element have been superimposed between two compression plates of a stoving shuttle.

This stoving shuttle can be of a similar nature to the one used to form the mould cavity as described above. Each tightening plate forming the stoving shuttle may include a silicone compression sole, each one preferably of a different Shore A hardness and in Shore A hardness ranges as mentioned above.

The shuttle is then inserted (e) into a moulding press to press said two plates against each other so as to compress the sheet of raw elastomeric material and the pre-moulded element into the moulding cavity and heated to a temperature between 150° C. and 220° C., preferably between 160° C. and 200° C., for at least 30 minutes to vulcanize the sheet of raw elastomeric material and the pre-moulded element together.

This heating can result from convection heating in a stove or, preferably, from conduction heating of the press jaws in contact with the metal parts of the shuttle plates. In practice, this second heating method is the most optimal in terms of controlling the heating temperature at the heart of the shuttle, and therefore the vulcanization temperature of the raw material sheet on the pre-moulded element. The heating can be adjusted according to an electronically regulated set point at the tightening press, thermocouples being integrated in the press jaws to continuously measure the contact temperature with the tightening shuttle and transmit the measurements to the press electronic control device for possible adjustment of the heating temperature taking into account a desired heating profile according to the thermal resistance parameters of the shuttle materials.

The jaws of the moulding press apply a pressure of at least 5 tonnes, preferably at least 7 tonnes, during the moulding, onto the compression plates of the stoving shuttle during the entire heating operation. In practice, such pressure is necessary to ensure a good bond between the materials, without creep out of the mould cavity when vulcanizing the raw sheet on the pre-moulded element.

It should also be noted that the moulding of several pre-moulded elements can be carried out simultaneously without affecting the quality of the latter. To do this, it is sufficient to stack, between as many compression plates as necessary, a plurality of cavities in each of which a said sheet of raw calendered elastomeric material and a pre-moulded element to be coated and textured have been placed. Advantageously, up to 6 elastomer parts can be moulded simultaneously, using 6 cavities and 7 compression plates, thus forming a stepped shuttle inserted between the jaws of the moulding press.

In such a simultaneous multi-moulded configuration, it is then important to ensure that silicone spacers are advantageously arranged between each compression plate and mould cavity on the one hand and the pre-moulded element on the other hand, in order to apply the most uniform pressure to each moulding stage.

Once baking is complete, the moulding press is then opened and the shuttle is taken out. The compression plates are then separated to access the thus moulded elastomeric part(s), bearing a texture conferred by transfer of the mould cavity on the portion from the mass-vulcanized sheet of raw calendered material, on the pre-moulded, now totally vulcanized element.

It is then sufficient to recover (f) the thus moulded parts for inspection, deburring, possible final machining and packaging for later final use.

The above description has been given as a non-exhaustive illustration of the invention, a preferred purpose of which may be to produce watch strap strands made of elastomeric material. However, the skilled person may adapt it without leaving the scope of the invention, in particular to produce various components of timepieces, such as inserts intended to be housed in watch rings, or parts of case bottoms or any other parts that can be made of elastomers and on which it may be interesting to affix a textured decorative element.

1. A method for making a textured moulding cavity, in particular for moulding elastomer parts with surface texturing, comprising the following steps:
Provide (1) a natural model whose surface condition is to be reproduced on an elastomer part;
Place (2) the natural model between two sheets of a first calendered elastomeric material to form a cavity acquisition assembly;
Place (3) the cavity acquisition assembly between two sheets of a second calendered elastomeric material different from the first elastomeric material calendered into elastomer so as to cover the cavity acquisition assembly;
Place (4) the whole between two compression plates of a stoving shuttle and close said shuttle by tightening said two plates against each other in order to compress the sheets of the second calendered material on the cavity acquisition assembly between said plates;
Heat the stoving shuttle for a period between 20 minutes and 60 minutes at a temperature between 80° C. and 200° C. to at least partially vulcanize each sheet of calendered elastomeric raw material and overmould said natural model in one face thereof;
Open the shuttle and remove the natural model from between the cavity acquisition blocks to obtain two textured moulding cavities comprising a sheet of calendered vulcanized elastomeric raw material at least partially vulcanized.

2. A method according to claim 1, characterized in that the first calendered elastomeric material is selected from a fluorinated elastomeric material, in particular of the FKM type, or nitrile (NBR).

3. A method according to claim 1, characterized in that the second calendered elastomeric material is ethylene propylene diene monomer (EPDM).

4. A method according to claim 1, characterized in that the shuttle tightening plates each comprise a silicone compression inner sole, said soles having a different Shore A hardness.

5. A method according to claim 4, characterized in that a first sole has a hardness between 20° and 30° Shore A and a second sole has a hardness between 40° and 50° Shore A.

6. A moulding cavity obtained with a production method according to claim 1.

7. A moulding cavity according to claim 6, characterized in that it comprises a first layer of a first elastomeric material having a textured moulding form and a second layer of a second calendered elastomeric material different from the first vulcanized one to the first layer on a face thereof opposite that with the textured moulding form.

8. A moulding cavity according to claim 6, characterized in that the first calendered elastomeric material comprises a fluorinated elastomeric material, in particular of the FKM type, or nitrile (NBR) and the second calendered elastomeric material comprises ethylene propylene diene monomer (EPDM).

9. A method for moulding a part of elastomeric material, comprising the following steps:
a. use a moulding cavity according to claim 6,
b. Place a sheet of raw calendered elastomeric material in said mould cavity;
c. Place on the sheet of raw calendered elastomeric material an element of partially vulcanized pre-moulded elastomeric material having substantially the shape of the part to be obtained, and
d. Place the mould cavity in which the sheet of raw elastomeric material and the pre-moulded element have been superimposed between two compression plates of a stoving shuttle and press said two plates together so as to compress the sheet of raw elastomeric material and the pre-moulded element into the cavity,
e. Heat the shuttle after closing to a temperature between 150° C. and 220° C., preferably between 160° C. and 200° C., for at least 30 minutes to vulcanize the sheet of raw elastomeric material and the pre-moulded element together to form a textured elastomer part;
f. After baking, separate the textured elastomer part thus formed, the face of which, obtained from the raw calendered material before baking in contact with the cavity, is textured.

10. A method according to claim 9, characterized in that the sheet of raw calendered material and the pre-moulded element are made of an elastomeric material of a similar chemical nature, so that they can be cross-linked together.

11. A method according to claim 9, characterized in that the sheet of raw calendered material and the pre-moulded element are made of an ethylene propylene diene monomer (EPDM).

12. A method according to claim 9, characterized in that the compression plates are held against each other under a pressure of at least 5 tons, preferably at least 7 tons, during the heating operation.

13. A method according to claim 9, characterized in that the pre-moulded element is vulcanized at least to T30 and at most to T80 before the heating step.

14. A method according to claim 9, characterized in that silicone spacers are provided between a compression plate and the mould cavity on the one hand and the other compression plate and the pre-moulded element on the other hand.

15. A textured elastomeric part obtained with a production method according to claim 9.
